(19) United States
(12) Patent Application Publication
(10) Pub. No.: US 2024/0137727 A1
(43) Pub. Date: Apr. 25, 2024

(54) ADJUSTMENT OF REVERBERATION LEVEL

(71) Applicant: Telefonaktiebolaget LM Ericsson (publ), Stockholm (SE)

(72) Inventor: Werner DE BRUIJN, Stockholm (SE)

(73) Assignee: Telefonaktiebolaget LM Ericsson (publ), Stockholm (SE)

(21) Appl. No.: 18/401,012

(22) Filed: Dec. 29, 2023

Related U.S. Application Data
(63) Continuation of application No. PCT/EP2022/068015, filed on Jun. 30, 2022.
(60) Provisional application No. 63/217,076, filed on Jun. 30, 2021.
(60) Provisional application No. 63/273,637, filed on Oct. 29, 2021.

(51) Int. Cl. H04S 7/00

(52) U.S. Cl. CPC H04S 7/305; H04S 7/301

(57) ABSTRACT

A method of rendering an audio source is provided. The method comprises receiving an input audio signal corresponding to the audio source and receiving a reverberation parameter indicating a target energy ratio with respect to a reverberant sound component of audio for the audio source. The method further comprises obtaining a directivity pattern of the audio source, deriving a relative gain for the audio source based on the obtained directivity pattern, wherein the relative gain is relative to an omnidirectional audio source, and generating an adjusted audio signal using the received input audio signal, the reverberation parameter, and the derived relative gain.

### CROSS REFERENCE TO RELATED APPLICATION(S)

This application is a continuation of International Patent Application No. PCT/EP2022/068015, filed Jun. 30, 2022, designating the United States, which claims the benefit of i) U.S. Provisional Application No. 63/217,076, filed Jun. 30, 2021 and ii) U.S. Provisional Application No. 63/273,637, filed Oct. 29, 2021. The above identified applications are incorporated herein by this reference.

### TECHNICAL FIELD

This disclosure relates to methods and apparatus for adjusting reverberation level.

### BACKGROUND

The MPEG-I audio standard for extended reality (such as virtual reality (VR), augmented reality (AR), and mixed reality (MR)) audio will define a parameter for an acoustic environment (either virtual or real) that specifies the relative level of (late) reverberation in the acoustic environment.

The parameter may have the form of a desired ratio between the level (e.g., energy level) of the direct sound component (or the emitted energy of an audio source) and the level of (late) reverberation of the audio source when the audio source is rendered in the acoustic environment. An audio renderer that receives the parameter may be able to render audio sources that are placed in the acoustic environment such that the listener receives the correct balance between the direct sound component and the reverberant sound component of rendered audio for each audio source, at all possible listening positions within the acoustic environment. The audio renderer may achieve this by appropriately setting the (relative) level of the processing unit that generates the (late) reverberation.

One example of this parameter is the so-called direct-to-reverberant energy ratio (DRR) or its inverse reverberant-to-direct energy ratio (RDR), determined at a predefined fixed distance (e.g., 1 m) from a predefined type of audio source (e.g., an omnidirectional point source).

A general description of this measure (i.e., the parameter) and conceptual methods for determining the measure and calibrating an audio renderer using the measure to set up its reverberation unit is described in additional information section (ISO/IEC JTC1/SC29/WG6 document number: M57352, July 2021) below.

### SUMMARY

The following challenges presently exist.

Configuration change of the reverberation unit—The conceptual procedures for determining the measure (RDR determined at a specific fixed position from an audio source of a specific type) and calibrating an audio renderer using the measure, which is disclosed in the additional information section below, should in principle only have to be carried out once in order to set the gain of the renderer's reverberation unit correctly (i.e., such that the calibration results in a desired balance between the direct sound component and the reverberant sound component, which is specified by the received value of the measure). Thus, it is not necessary to recalibrate the gain of the reverberation unit for individual sources, individual scenes, and/or acoustic environments. However, this is not the case when the configuration of the reverberation unit itself is changed such that its input/output relationship changes, e.g., loading a different room impulse response, setting a new reverberation time, etc. In such situations, the gain of the reverberation unit needs to be re-calibrated for the new configuration.

Rendering of non-omnidirectional sources—Since the measure is defined to be determined for a specific fixed source type, i.e., an omnidirectional point source and the calibration of the gain of the renderer's reverberation unit will typically be done with the same type of source, rendering sources that are non-omnidirectional and/or have non-point like behavior (i.e., not having a distance attenuation that follows the 1/r law of a point source), may not result in the correct balance between the direct sound component and the (late) reverberation part at all listening positions.

Variations in definitions of the direct sound component and reverberant sound component-The measure defined in the additional information section below allows different choices for setting the temporal boundaries of the direct sound component and the reverberant sound component. A different choice at the authoring side (which determines the value of the measure) and the renderer side may lead to non-optimal results.

Rendering of audio sources with different reference distances for the distance attenuation function—The MPEG-I Audio standard allows setting a so-called “reference distance.” The “reference distance” is a distance from the audio source at which the distance attenuation of the audio source is defined to be 1. Rendering an audio source with a “reference distance” having a value that is different from the default value specified in the standard may result in an incorrect balance between the direct sound component and the reverberant sound component of audio for the source.

Accordingly, in one aspect, there is provided a method of rendering an audio source. The method comprises receiving an input audio signal corresponding to the audio source and receiving a reverberation parameter indicating a target energy ratio between a direct sound component of rendered audio for the audio source and a reverberant sound component of the rendered audio for the audio source. The method further comprises deriving a relative gain associated with a first configuration of a reverberation unit, wherein the relative gain is with respect to a reference configuration of the reverberation unit and generating an adjusted audio signal using the received input audio signal, the received reverberation parameter, and the derived relative gain.

In another aspect, there is provided a method of rendering an audio source. The method comprises receiving an input audio signal corresponding to the audio source and receiving a reverberation parameter indicating a target energy ratio between a direct sound component of rendered audio for the audio source and a reverberant sound component of the rendered audio for the audio source. The method further comprises obtaining a directivity pattern of the audio source and deriving a relative power level for the audio source based on the obtained directivity pattern, wherein the relative power level is relative to a power level of an omnidirectional audio source. The method further comprises generating an adjusted audio signal using the received input audio signal, the reverberation parameter, and the derived relative power level.

In another aspect, there is provided a method of rendering an audio source. The method comprises receiving an input audio signal corresponding to the audio source and receiving a reverberation parameter indicating a target energy ratio between a direct sound component of rendered audio for the audio source and a reverberant sound component of the rendered audio for the audio source. The method further comprises obtaining a first variable indicating an upper time limit for the direct source component and a second variable indicating a lower time limit for the reverberant sound component and generating an adjusted audio signal using the received input audio signal, the reverberation parameter, the obtained first variable, the obtained second variable.

In another aspect, there is provided a method of rendering an audio source. The method comprises receiving an input audio signal corresponding to the audio source and receiving a reverberation parameter indicating a target energy ratio between a direct sound component of rendered audio for the audio source and a reverberant sound component of the rendered audio for the audio source. The method further comprises deriving a relative gain corresponding to a first associated reference distance of the audio source, wherein the relative gain is with respect to a default reference distance and generating an adjusted audio signal using the received input audio signal, the received reverberation parameter, and the derived relative gain.

In another aspect, there is provided a computer program comprising instructions which when executed by processing circuitry cause the processing circuitry to perform the method described above.

In another aspect, there is provided an apparatus comprising a memory and processing circuitry coupled to the memory, wherein the apparatus is configured to perform the method described above.

In a different aspect, there is provided a method of rendering an audio source. The method comprises receiving an input audio signal corresponding to the audio source; receiving a reverberation parameter indicating a target energy ratio with respect to a reverberant sound component of audio for the audio source; and deriving one or more of (i) a relative gain associated with a first directivity pattern of the audio source, (ii) a relative gain associated with a first reference distance of the audio source, (iii) a relative gain associated with a first configuration of a reverberation unit, and (iv) a relative gain associated with a first time limit for the reverberant sound component. The method further comprises generating an adjusted audio signal using the received input audio signal, the received reverberation parameter, and any one or more of the derived relative gains (i)-(iv) above, wherein the relative gain associated with the first directivity pattern is with respect to a reference directivity pattern, the relative gain associated with the first reference distance is with respect to a default reference distance, the relative gain associated with the first configuration is with respect to a reference configuration of the reverberation unit, and the relative gain associated with the first time limit is with respect to a second time limit for the reverberant sound component.

In a different aspect, there is provided a method of rendering an audio source. The method comprises receiving an input audio signal corresponding to the audio source; and receiving a reverberation parameter indicating a target energy ratio with respect to a reverberant sound component of audio for the audio source. The method further comprises obtaining a directivity pattern of the audio source, deriving a relative power level for the audio source based on the obtained directivity pattern, wherein the relative power level is relative to a power level of an omnidirectional audio source, and generating an adjusted audio signal using the received input audio signal, the reverberation parameter, and the derived relative power level.

In a different aspect, there is provided a method of rendering an audio source. The method comprises receiving an input audio signal corresponding to the audio source; receiving a reverberation parameter indicating a target energy ratio with respect to a reverberant sound component of audio for the audio source; deriving a relative gain corresponding to a first associated reference distance of the audio source; and generating an adjusted audio signal using the received input audio signal, the received reverberation parameter, and the derived relative gain.

In a different aspect, there is provided a method of rendering an audio source. The method comprises receiving an input audio signal corresponding to the audio source; receiving a reverberation parameter indicating a target energy ratio with respect to a reverberant sound component of the rendered audio for the audio source; obtaining a variable indicating a lower time limit for the reverberant sound component; and generating an adjusted audio signal using the received input audio signal, the reverberation parameter, and the obtained variable.

In a different aspect, there is provided a method of rendering an audio source. The method comprises receiving an input audio signal corresponding to the audio source; and receiving a reverberation parameter indicating a target energy ratio with respect to a reverberant sound component of the rendered audio for the audio source. The method further comprises deriving a relative gain associated with a first configuration of a reverberation unit, wherein the relative gain is with respect to a reference configuration of the reverberation unit; and generating an adjusted audio signal using the received input audio signal, the received reverberation parameter, and the derived relative gain.

In a different aspect, there is provided a computer program comprising instructions which when executed by processing circuitry cause the processing circuitry to perform the method according to at least one of the embodiments described above.

In a different aspect, there is provided an apparatus comprising a processing circuitry; and a memory, said memory containing instructions executable by said processing circuitry, whereby the apparatus is operative to perform the method according to at least one of the embodiments described above.

### Advantages

The embodiments of this disclosure provide an efficient way of providing the desired balance between the direct sound component of rendered audio for an audio source and the (late) reverberant sound component of the rendered audio for the audio source.

To achieve the above advantages, some embodiments of this disclosure provide a convenient method for determining and setting the correct relative gain for a reverberation unit in the audio renderer in case there is a change to the configuration of the reverberation unit that changes the input-output relationship of the unit.

In other embodiments, there is provided a method for adapting the rendering of reverberation for audio sources that are non-omnidirectional and/or non-point source like such that the obtained balance between the direct sound component and the reverberant sound component is correct at all listening positions for such sources.

In further embodiments, there are provided methods for obtaining a reverberation parameter and an associated variable indicating lower time limit for the reverberant sound component from the authoring side such that the obtained variable is used for modifying the reverberation parameter, thereby generating an adjusted audio signal at the audio renderer.

### BRIEF DESCRIPTION OF THE DRAWINGS

The accompanying drawings, which are incorporated herein and form part of the specification, illustrate various embodiments.

FIG. 1a shows components of an audio rendered to a user.

FIG. 1b shows the ending time of the direct sound component and the starting time of the reverberation sound component.

FIG. 2 shows a system according to some embodiments.

FIG. 3 shows a process according to some embodiments.

FIG. 4 shows a process according to some embodiments.

FIG. 5 shows a process according to some embodiments.

FIG. 6 shows a process according to some embodiments.

FIG. 7 shows a process according to some embodiments.

FIG. 8 shows an apparatus according to some embodiments.

FIG. 9 shows an energy decay curve.

FIG. 10 shows a process according to some embodiments.

FIG. 11 shows a process according to some embodiments.

FIG. 12 shows a process according to some embodiments.

FIG. 13 shows a process according to some embodiments.

FIG. 14 shows a process according to some embodiments.

### DETAILED DESCRIPTION

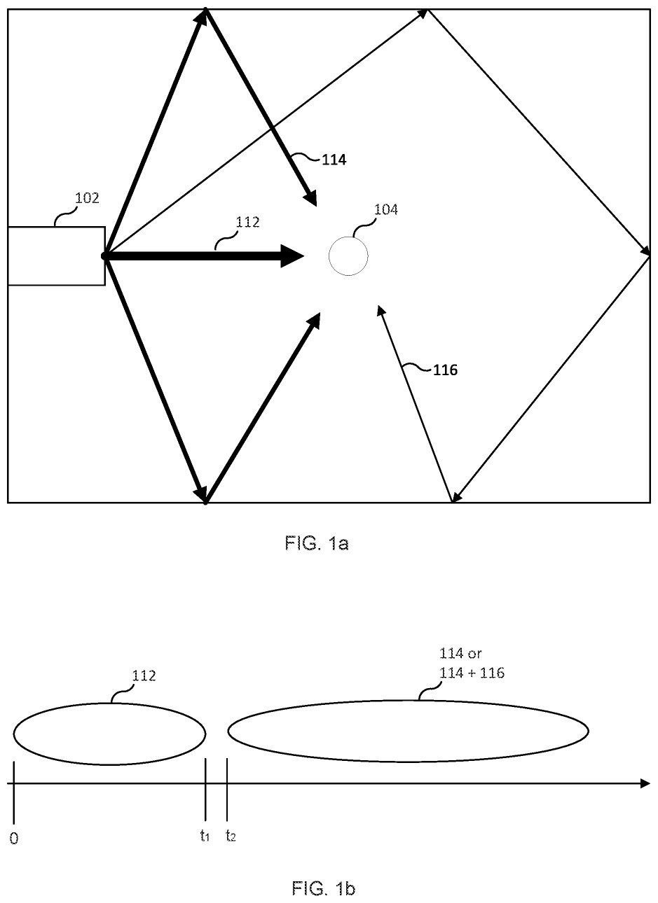

FIG. 1a illustrates how an audio source 102 may be rendered to a user 104. As shown in FIG. 1a, the audio source 102 may be rendered to the user 104 via direct sound component 112, early reflected sound component 114, and late reflected sound component 116.

As discussed above and in the additional information section below, the definition of the RDR (or DRR) measure allows different choices for the temporal boundaries of the direct and reverberant sound components used for calculating the measure. The resulting measure with any such choice for the temporal boundaries may be generally referred to as “direct-to-reverberant energy ratio.” For example, with some choices of the temporal boundaries, the direct-to-reverberant energy ratio may refer to the ratio between the energy of the direct sound component 112 and the energy of all reflected sound components 114 and 116, while for some other choices of the temporal boundaries the direct-to-reverberant energy ratio may refer to the ratio between the energy of the direct sound component 112 and the energy of only the diffuse component of the room impulse response (i.e., only the late reflected sound component 116). In the latter case, the resulting RDR (or DRR) measure may be referred to as “direct-to-diffuse” energy ratio. For yet other choices of the temporal boundaries, the reverberant sound component used in the RDR (or DRR) measure may include some, but not all, reflected sound components arriving before the diffuse part of the room impulse response begins. For simple explanation, the terms “direct-to-reverberant energy ratio,” “direct-to-diffuse energy ratio”, RDR and DRR are used synonymously in this disclosure, unless where noted otherwise, and are generally referred to as an “energy ratio.”

Thus, any variation of the energy ratio, including those described above and their inverses, is applicable to the embodiments of this disclosure. For example, equation (1) in the additional information section below accommodates the use of any of the variations of the “energy ratio” by having separate parameters t1 and t2, where t1 marks the end of the direct sound component of the room impulse response and t2 marks the start of the “reverberant” part of the room impulse response. The parameter t2 may be chosen such that it marks either of the start of the non-direct sound component of the room impulse response , the start of the diffuse component of the room impulse response (i.e., “direct-to-diffuse” ratio definition), or some other selected start time of the “reverberant” component (e.g., a time instant somewhere between the start of the non-direct sound component and the start of the diffuse component of the room impulse response). The parameters t1 and t2 are illustrated in FIG. 1b.

The end of the direct sound component, marked by t1, may be chosen such that the direct sound component only includes the direct sound peak of the impulse response. Alternatively, the end of the direct sound component may be chosen such that the direct sound component not only includes the direct sound peak but also includes some very early reflections. The end of the direct sound component may be chosen to include some very early reflections because perceptually these very early reflected sound components integrate with the direct sound component. The direct sound component and those very early reflected sound components are perceived as one sound event from the direction of the direct sound, where the very early reflected sound components result in a higher perceived level of the direct sound.

Even though the embodiments of this disclosure are explained using RDR which is determined at a predefined distance from a predefined type of audio source, the embodiments are equally applicable to alternative, related measures that result from different choices for the parameters t1 and t2 (such as the diffuse-to-direct ratio). Similarly, the embodiments of this disclosure are applicable to measures that use an alternative metric to the direct sound energy metric in the denominator of the RDR measure (provided in the equation 1 in the additional information section below)—e.g., the total emitted source energy (i.e., resulting in a reverberant/diffuse-to-emitted-source-energy ratio). In other words, in some embodiments, instead of the RDR (or DRR, direct-to-reverberant energy ratio, direct-to-diffuse energy ratio), a different energy ratio with respect to a reverberant sound component of the audio for the audio source may be used, e.g., a ratio between the total energy emitted by the audio source and the energy corresponding to the reverberant sound component of the audio for the audio source (e.g., the energy corresponding to the late reflected sound component 116 or the energy corresponding to the combination of the early reflected sound component 114 and the late reflected sound component 116). In summary, the embodiments apply to a “family” of metrics that are indicative of the energy ratio between reverberant sound components and non-reverberant components of rendered audio for an audio source.

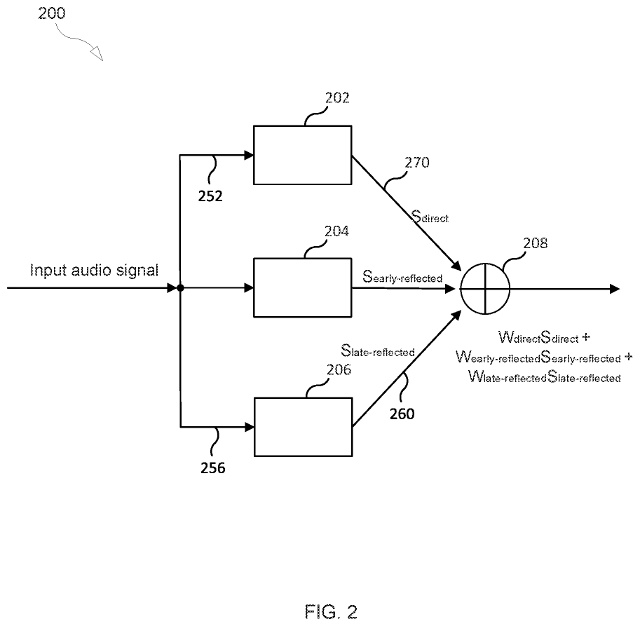

FIG. 2 shows a system 200 according to some embodiments. The system 200 may be used for rendering an audio source. The system 200 may comprise a direct sound component unit 202, early reflected sound component unit 204, late reflected sound component unit 206, and a combiner 208. In this disclosure, either the late reflected sound component unit 206 or the combination of the early reflected sound component unit 204 and the late reflected sound component unit 206 is referred to as a reverberation unit. Similarly, the late reflected sound component or a combination of the early reflected sound component and the late reflected sound component are referred as a reverberant sound component.

Upon receiving an input audio signal, the direct sound component unit 202 may generate a direct sound component signal based on the received input audio signal. Similarly, the early reflected sound component unit 204 may generate an early reflected sound component signal based on the received input audio signal and the late reflected sound component unit 206 may generate a late reflected sound component signal based on the received input audio signal. The combiner 208 may be configured to combine the three generated signals into an output audio signal. In some embodiments, the combination of the three generated signals may be a weighted combination of the three generated signals. For example, sₒᵤₜₚᵤₜ=w_{direct}s_{direct}+w_{early-reflected}s_{early-reflected}+w_{late-reflected}s_{late-reflected}.

Different methods and/or systems may be implemented in the reverberation unit for reverberation generation process. Examples of such methods and/or systems include delay networks (simulating the reverberation process using delay lines, filters, and feedback connections), convolution algorithms (convolving a dry input signal with a recorded, approximated, or simulated room impulse response (RIR)), computational acoustics (simulating the propagation of sound in a specified geometry), and virtual analog models (simulating electromechanical or electrical devices used formerly for producing reverberation effects (tapes, plates, springs)).

Some embodiments described below are directed to a method of rendering an audio source using a relative gain. Here, the relative gain is a gain related to the reverberation unit. For example, the relative gain may be a gain applied within the reverberation unit. In such example, by applying the gain within the reverberation unit, the reverberation unit generates an adjusted reverberation audio signal.

In another example, the relative gain may be a gain applied to an input audio signal provided to the reverberation unit. By applying a gain to the input audio signal, a revised input audio signal is provided to the reverberation unit, and thus the reverberation unit generates an adjusted reverberation audio signal. In a different example, the relative gain may be a gain applied to an output audio signal outputted from the reverberation unit. In such example, by applying the gain to the output audio signal, an adjusted reverberation audio signal is generated.

Detailed explanation as to how the relative gain is derived in each of the different embodiments is provided below.

### 1. Adaptation to a Change in the Configuration of a Reverberation Unit

The method for calibrating an audio renderer, which is described in section 4 of the additional information section below may only need to be carried out once for the audio renderer as long as there is no change in the configuration of a reverberation unit included in the audio renderer. In other words, one calibration procedure carried out for one (e.g., arbitrary) acoustic environment may be sufficient to set a relative gain (e.g., energy gain) of the reverberation unit such that audio sources rendered at any position in any acoustic environment using the reverberation unit would result in the desired balance between the direct sound component and the reverberant sound component, as specified by a given value of the RDR parameter.

Even in the scenario where the value of the RDR parameter is changed, adjusting the relative gain of the reverberation unit (included in an audio renderer) to achieve the desired balance of the direct sound component and the reverberant sound component as specified by a given RDR parameter is straightforward. In particular, changing the relative gain of the reverberation unit by the same amount as the change in the value of the RDR may produce the desired result.

However, when a change is made to the configuration of the reverberation unit such that the input-output relationship of the reverberation unit is changed, achieving the desired balance of the direct sound component and the reverberant sound component is not straightforward. Examples of such change that changes the input-output relationship of the reverberation unit are any one or a combination of loading a different room impulse response (RIR), setting a different reverberation time (RT, RT60), setting different absorption characteristics, etc.

In such cases, the output of the reverberation unit in response to a given input audio signal will in general be different in terms of temporal and/or spectral aspects (e.g., the temporal length of the reverberant response, the temporal density of reflections, temporal-spectral shape of the response, etc.). Also the changes of the input-output relationship of the reverberation unit may also result in a different output level for the reverberation unit in response to a given input signal, thereby resulting in a different ratio of the direct sound component and the reverberant sound component at a listener position as before the change (assuming the rendering of the direct sound component is not changed).

One way to solve the aforementioned problem is calibrating the reverberation unit as described in section 4 of the additional information section below for a new configuration of the reverberation unit. This, however, has the disadvantage that performing the calibration procedure takes some time, which may be undesirable or even unacceptable in real-time rendering applications.

If the reverberation unit has a finite set of configurations that it uses, then the calibration can be done offline in advance for each of the configurations and the corresponding resulting relative gain of the reverberation unit for each of the configurations can be stored, retrieved, and applied as needed.

By calibrating each of the available configurations, the derived relative gain of the reverberation unit for each of the configurations of the reverberation unit accounts for both the input-output level relationship of the reverberation unit with the specific configuration, and the level of the reverberation unit relative to the other rendering units (in particular the direct sound rendering unit).

Calibrating the reverberation unit for each configuration, however, is not strictly necessary and may result in relative gains of the reverberation unit, which include redundant information. Indeed, the only information that may be needed to derive the required correction of the gain of the reverberation unit may be the change in output level of the reverberation unit in response to a given input signal.

Since this relationship is purely a property of the reverberation unit, this change in output level can be determined completely independent of the other components of the renderer system.

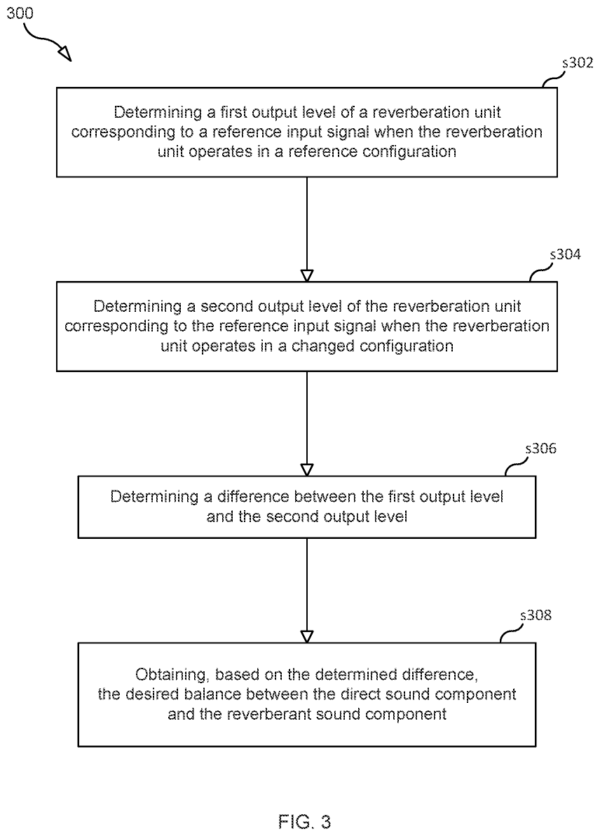

Therefore, according to embodiments of this disclosure, a method 300 shown in FIG. 3 may be used in order to derive the change in output level.

The method may begin with step s302. Step s302 comprises determining a first output level (e.g., the energy level) of the reverberation unit corresponding to a reference input signal when the reverberation unit operates in a reference configuration.

The reference input audio signal may be any audio signal that is suitable for determining the input-output energy level relationship of the reverberation unit. Examples of the reference input audio signal are: a steady-state white noise signal, a dirac pulse, a sine-sweep signal, a pseudo-random noise (Maximum-Length Sequence (MLS)) signal, etc.

Referring back to FIG. 3, step s304 comprises determining a second output level (e.g., the energy level) of the reverberation unit corresponding to the same reference input signal when the reverberation unit operates in a changed configuration that is different from the reference configuration.

Step s306 comprises determining a difference between the first output level and the second output level.

Step s308 comprises obtaining, based on the determined difference, the desired balance between the direct sound component and the reverberant sound component. For example, the desired balance may be obtained by applying the determined difference as an extra gain or attenuation to the original gain of the reverberation unit.

If the audio renderer has been calibrated for the reference configuration of the reverberation unit as described in section 4 of the additional information section below, once a difference in the output level is obtained using the above method, the desired balance between the direct sound component and the reverberant sound component can be obtained (achieved) for each of different configurations by simply compensating the relative gain of the reverberation unit with the difference.

The following scenario illustrates how the method 300 shown in FIG. 3 may be used.

Suppose that an audio renderer that includes the reverberation unit has been calibrated with reverberation unit configuration A which includes a room impulse response RIR_A and the RDR parameter having the value of −6 dB (i.e., having a reverberant-to-direct energy ratio of 0.25 on a linear energy ratio scale).

Also suppose that information about a new scene is received and the information contains an acoustic environment with a specified desired RDR value of −10 dB (i.e., 0.1 on a linear energy ratio scale). In order to achieve the desired ratio of the direct sound component and the reverberant sound component, the relative gain of the reverberation unit needs to be decreased by 4 dB (by a factor of 2.5 in terms of energy or a factor of 1.6 in terms of linear gain).

Further suppose that a configuration change of the reverberation unit from the configuration A to a configuration B is triggered (either by metadata contained in the scene information or by some other trigger), which means that a new room impulse response RIR_B is loaded.

Here, the change in the output level of the reverberation unit due to the configuration change may be determined using the process described above and it is determined that the change is, for example, +3 dB (i.e., the new configuration with RIR_B results in a 3 dB higher output level than the old configuration A with RIR_A). This means that in order to maintain the correct ratio of the direct sound part and the reverberant sound part, the relative gain of the reverberation unit needs to be reduced by 3 dB.

Alternatively, in the specific case of changing between two RIRs, the change in the input-output relationship may also be derived directly from calculating the energies of the RIRs, for example, by integrating the square of the RIRs and comparing the resulting energies for the two RIRs. In some situations, this method may be more efficient than the process described above because the energy of each RIR may be stored with the RIR as metadata that can be used directly by the audio renderer to make the required adjustment to the relative gain of the reverberation unit.

Referring back to the example described above, combining the two changes (the change to the scene with RDR parameter value of −10 dB and the configuration change of the reverberation unit from RIR_A to RIR_B), the relative gain of the reverberation unit should be decreased by 4+3=7 dB in order to obtain the desired ratio (which is specified in the RDR parameter) of the direct sound component to the reverberant sound component (as specified in the value of the RDR parameter) in the overall rendered output.

Another example of a configuration change is when the reverberation time (RT60) for the reverberation unit is changed. If a shorter RT60 is set for the reverberation unit, this typically results in a lower output level for the reverberation unit (as the impulse response contains less energy). In this case, the same process as described above may be used to determine the change in the output level of the reverberation unit.

However, in this specific case, there is also a simpler, more direct way to determine the change. From statistical acoustics formulas, it can be derived that on a linear scale the reverberant-to-direct energy ratio is proportional to RT60. More specifically, when RT60 is halved compared to the RT60 value used for calibrating the audio renderer, so is the resulting reverberant-to-direct energy ratio on a linear scale (in other words: it is reduced by 3 dB on a decibel scale).

This means that there is a direct approximate relationship between the change in RT60 and the change in relative gain of the reverberation unit that is required to obtain the correct ratio between the direct sound part and the reverberant sound part. Thus, in this example, the relative gain of the reverberation unit would have to be increased by 3 dB (10*log(2)) in order to achieve the correct balance.

Similar direct relationships between changes in other parameters of the reverberation unit and its corresponding output level may exist and be used advantageously such that instead of using the method 300 shown in FIG. 3 to determine the change in output level, a deterministic relationship may be used instead.

Even though RIR and RT60 are used as examples, the method 300 shown in FIG. 3 for determining the change in the output level due to a change of configuration equally applies to any other type of changes to the configuration of the reverberation unit.

Also, even though the examples above discuss two isolated changes (RIR and RT60) to the configuration of the reverberation unit, there may be several simultaneous changes when switching between configurations. In such case, the method 300 shown in FIG. 3 may conveniently lump the effects of all those changes together to result in one value for the overall change of the output level of the reverberation unit.

2. Rendering Audio Sources that are Not Omnidirectional and/or are Not Point Sources

The RDR parameter discussed in the additional information section below and the method, discussed in the additional information section below, for deriving the RDR parameter and calibrating an audio renderer using the RDR parameter, are determined based on the assumption that the audio source is an omnidirectional point source—i.e., an audio source that radiates evenly in all directions and has a distance attenuation function that is inversely proportional to the distance (e.g., f(r)=1/r).

If the audio source to be rendered has these characteristics of the omnidirectional point source, the calibrated audio renderer will produce audio having the correct balance between the direct sound part of the audio and the reverberant sound part of the audio for any combination of the position of the audio source and the listener position in any acoustic environment (as long as the configuration of the reverberation unit is not changed as discussed above).

However, many audio sources to be rendered in VR and AR systems do not have the characteristics of the omnidirectional point source. More specifically, many audio sources to be rendered in VR and AR systems have a defined non-omnidirectional radiation pattern (e.g., specified in metadata accompanying the audio source). Rendering such audio sources without any special measures may not result in the correct balance between the direct sound part of the audio and the reverberant sound part of the audio at some (or all) listening positions.

If in a real-world situation there are an omnidirectional sound source and a directional sound source which have equal source amplitudes (or equal source signal levels in terms of an audio rendering system) and are placed at the same position in the same room, the level of the direct sound part perceived at a listener position for each of the sound sources may easily be determined by simply looking at the value of the respective directivity pattern of each of the sound sources in the direction of the listener position.

For the omnidirectional sound source, the value of the directivity pattern for the source may be assumed to be 1 in all directions while for the directional sound source, the value for the directivity pattern for the sound source may be assumed to have a value between 0 and 1 in any direction (different conventions for defining and/or normalizing the directivity pattern can be used in the embodiments of this disclosure).

The level of the (late) reverberation component of the sound for any sound source is essentially constant throughout a room in which the sound source is located and is determined by the total radiated power of the sound source. This means that a directional sound source having a directivity pattern that is normalized to 1 in its direction of highest sound radiation has a lower total radiated power as compared to the total radiated power of a normalized omnidirectional sound source having the same source amplitude, and may therefore produce a lower level of reverberation in the room. More generally speaking (i.e., not restricting to directivity patterns normalized to 1), a directional sound source will in general produce a different level of reverberation in the room as compared to an omnidirectional source having the same source amplitude.

In case there are in a VR audio rendering system an omnidirectional audio source and a directional audio source that have equal source signal levels (e.g., the same audio input signal is sent to each of the two audio sources), the rendering of the direct sound component of the audio is relatively straightforward for both types of the audio source. Furthermore, the rendering of the direct sound component for the directional audio source may be achieved using a simple scaling of the amplitude of the audio input signal by the value of the directivity pattern in the direction of the listener.

The correct rendering of the reverberant sound component of the directional source, however, requires more careful treatment. Since the RDR parameter discussed in the additional information section below, the methods for determining the RDR parameter, and calibrating the audio renderer are all based on the assumption that the audio source is an omnidirectional source (and/or a point audio source), the reverberant sound component of the directional audio source (and/or a non-point audio source) may not be rendered with the proper relative level (that is relative to the direct sound component).

More specifically, since the relative gain of the reverberation unit is set according to the calibration procedure that assumes that the audio source is an omnidirectional source (and/or a point audio source), if the reverberation unit is fed with a first input signal of an omnidirectional audio source (and/or a point audio source) and a second input signal of a directional audio source (and/or a non-point audio source) that both have the same signal level, the reverberation unit may produce the same reverberation output level for both whereas the output levels should be different to reflect the different source power of the two sources.

Thus, in some embodiments of this disclosure, to correct the relative level of reverberation for the directional audio source (and/or the non-point audio source), the input gain of the reverberation unit for the signal of the directional source (and/or the non-point audio source) may be modified (i.e., the signal level of the input audio signal going into the reverberation unit may be changed) in order to take into account the fact that the input signal level corresponds to a directional source (and/or the non-point audio source) having a lower or a different source power.

The relative source power of the directional audio source (and/or the non-point audio source) with respect to the omni directional audio source (and/or the point audio source) may be determined from the directivity pattern of the directional audio source (and/or the non-point audio source). For example, the relative source power may be determined by integrating the directivity pattern (expressed in units of power) of the directional source (e.g., as specified in its accompanying directivity metadata) over the unit sphere and normalizing the obtained source power with the source power for the omnidirectional audio source determined in the same way.

Thus, if the directivity pattern of the directional audio source is specified in terms of a linear source amplitude p, then the relative source power of the directional source (relative to the omnidirectional source) may be equal or proportional to the square of the amplitude p averaged over the unit sphere: relative source power=p̅²̅.

Using the obtained relative source power of the directional audio source (and/or the non-point audio source) (compared to the omnidirectional audio source and/or the point audio source)), a relative gain for generating an adjusted audio signal 260 (shown in FIG. 2) may be generated. There may be various ways for generating the adjusted audio signal 260 using the relative gain. In one embodiment, the relative gain may be used to adjust the level of an input audio signal 256 corresponding to the directional source that is provided to the late reflected sound component unit 206, thereby generating the adjusted audio signal 260. In another embodiment, the relative gain may be used to adjust the level of the signal outputted from the late reflected sound component unit 206, thereby generating the adjusted audio signal 260. In a different embodiment, the relative gain may be used to adjust the configuration of the late reflected sound component unit 206 such that the unit generates the adjusted audio signal 260.

For example, if the averaging of the directivity pattern of the directional audio source indicates that the relative power of the directional audio source is half of the power of an omnidirectional point source, then the level of the input signal for the directional audio source going into the reverberation unit should be lowered by 3 dB.

The above described correction method for non-omnidirectional sources can also be used for sources that have non-point like distance attenuation behavior, i.e. that do not follow the 1/r distance law of a point source. Examples of such sources are line audio sources (which have a 1/sqrt) distance attenuation curve), planar audio sources, or volumetric audio sources in general. U.S. patent application Ser. No. 17/344,632 disclose models for deriving the distance attenuation behavior of all these types of sources as a function of the size of the source in different dimensions. These documents are hereby incorporated by reference.

In augmented reality scenarios where the value of the RDR parameter may have to be derived in a real-world environment using real-world (i.e. non ideal) sound sources that are neither omnidirectional nor point sources, the above corrections for directivity pattern and/or non-point source behavior can also be applied to correct the RDR value derived from measurements (a footnote in section 3 of the additional information section below already suggests a similar correction for a measurement distance that is different from the prescribed one). The same holds for use cases where, at the content authoring side, the value of the RDR parameter is derived from room impulse responses that were not obtained with an omnidirectional point source at the prescribed distance. As long as the directivity pattern, measurement distance, and distance attenuation function are known, all of these may be corrected for.

### 3. Providing the Time Variables to an Audio Renderer

The equation 1 in the additional information section below contains two time variables t1 and t2 (shown in FIG. 1b). t1 represents the upper integration limit (ending time) of the direct sound energy component 112 (denominator) and t2 represents the lower integration limit (starting time) of the reverberant sound energy component 114 or the combination of 114 and 116 (numerator). Even though FIG. 1b shows that t1 and t2 have different values, they may have the same value.

Different renderer implementations may distribute the generating and rendering of reverberant sound components of diffuse (or late) reverberation and early reflection sound components of the reverberation differently. For example, in one implementation, the reverberation unit only generates the diffuse sound component of the reverberation and a separate unit generates the early reflection sound component of the reverberation. On the other hand, in another implementation, the reverberation unit may generate both of these components. Yet in the other implementations, the generating and rendering of the reverberant part of the sound of a rendered audio source (i.e., everything except the direct sound component) may be divided in different ways, for example, over a different number of processing units or with different “handover” times between the units. These different implementations may be accommodated by choosing the parameters t1 and t2 in the equation 1 of the additional information section below.

For example, in case the reverberation unit generates all the reverberant sound, the value of t1 may be the time at which the direct sound component ends, and t2 may be equal to t1 (so they connect in time). However, in another case where the direct sound component also includes some very early reflections (since these integrate perceptually with the actual direct sound component), the value of t1 may be a bit larger than in the first case while t2 is still equal to t1. Yet, in another case where the reverberation unit only generates the diffuse part of the reverberation, the value of t2 may be larger than t1 so that the two intervals do not connect in time.

If the values of the parameters t1 and t2 selected at the authoring side (where the value of the RDR measure is determined) are different from either or both of the values of the parameters t1 and t2 selected at the renderer side (where the balance of the direct sound component and the reverberant sound component is set to match the received value of RDR), the balance of the direct sound component and the reverberant sound component produced by the renderer may not be entirely the same as the balance intended by a creator (e.g., a scene creator who created the extended reality (XR) scene including the audio source).

Thus, it is desirable to select the values of the parameters t1 and t2 at the renderer side to be the same as the values of the parameters t1 and t2 selected at the authoring side. Accordingly, in some embodiments of this disclosure, the values of the parameters t1 and/or t2 selected at the authoring side are sent to the renderer along with the RDR parameter. By receiving the parameters t1 and/or t2 selected at the authoring side, the renderer can set its parameters t1 and/or t2 to be the same as the received parameters, thereby producing the balance intended by the creator.

Alternatively, the renderer may modify the received RDR (or any other energy ratio discussed above) parameter to account for the different values of the parameters t1 and/or t2 selected at the authoring side and the values of the parameters t1 and/or t2 selected at the renderer side, and use the modified RDR parameter to produce the balance between the direct sound component and reverberant sound component as intended by the creator. For example, the relative gain of the reverberation unit may be changed by the same amount as the change in the value of the RDR parameter.

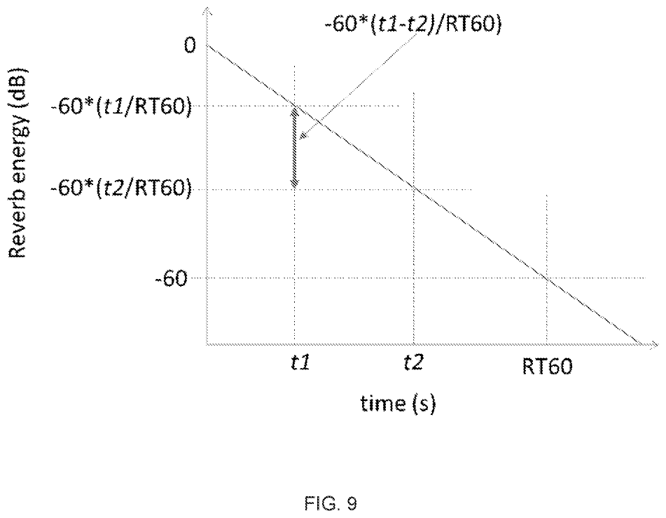

Specifically, the modification to account for different values of the parameter t2 between the authoring side and renderer side may be based on a diffuse field approximation of the reverberant sound. On a logarithmic (dB) scale, the so-called Energy Decay Curve of a fully diffuse sound field is a straight line with a slope of −60/RT60 (dB/s) (see FIG. 9). This implies that, in a diffuse field, the difference between RDR values (expressed in dB) determined with values of the parameter t2 of t2_1 and t2_2, respectively, is given by:

$$- 60 \times ( \frac{t 2 \_ 1 - t 2 \_ 2}{RT 60} ) ( dB ) . \qquad ( Eq . 1 )$$

where the value of the RDR parameter is higher for the smallest one of t2_1 and t2_2. If we now define t2_1 and t2_2 to be the values of the t2 parameter corresponding to the renderer and to the received RDR parameter, respectively, then the received RDR parameter (expressed in dB) may be modified to correct for the different values of the parameter t2 as follows:

$$R D {R}_{modified} = R D {R}_{received} - 60 \times ( \frac{t 2 \_ 1 - t 2 \_ 2}{RT 60} ) ( dB ) .. \qquad ( Eq . 2 )$$

If the parameter t2=t2_2 of the received RDR parameter is larger than the renderer's parameter t2=t2_1, then the result of the modification is that the received RDR value is increased, whereas it is decreased if t2_2 is smaller than t2_1. Note that if the RDR is expressed on a linear energy scale instead of on a logarithmic dB scale as used above, then equation 2 takes the form of multiplying the received RDR by a correction factor.

As explained, the value t2_2 of the parameter t2 corresponding to the received RDR parameter may be received by the renderer as additional metadata for the XR scene. Alternatively, it may be obtained in any other way, e.g., implicitly from the fact that it is known that the received RDR value was determined according to a certain definition (e.g., because the XR scene is in a specific known, e.g., standardized, format). As one example of this, the MPEG-I Encoder Input Format [ISO/IEC JTC1/SC29/WG6 output document N0054: “MPEG-I Immersive Audio Encoder Input Format”] prescribes that the value of the parameter t2 is equal to 4 times the acoustic time-of-flight associated with the longest dimension of the acoustical environment. Hence, in the latter example, from the fact that the received XR content has been encoded according to the MPEG-I standard, the renderer would be able to determine the value of the parameter t2 associated with the received RDR parameter by itself. In cases where the parameter t2 associated with the received RDR parameter has a known fixed value (e.g., because the standard according to which the XR scene has been formatted prescribes a fixed value for the t2 parameter), the value of the parameter t2 associated with the received RDR parameter may even be “baked in” in equations used by the renderer to calculate the modification to the received RDR parameter.

As discussed above, in some embodiments, the relative gain of the reverberation unit may be changed by the same amount as the change in the value of the RDR parameter. Once the changed relative gain is obtained, the adjusted audio signal 260 may be generated using the changed relative gain (herein after, “relative gain”). In one embodiment, the relative gain may be used to adjust the level of an input audio signal 256 corresponding to a source with the received RDR value, thereby generating the adjusted audio signal 260. In another embodiment, the relative gain may be used to adjust the level of the signal outputted from the late reflected sound component unit 206, thereby generating the adjusted audio signal 260. In a different embodiment, the relative gain may be used to adjust the configuration of the late reflected sound component unit 206 such that the unit generates the adjusted audio signal 260.

### 4. Rendering of Sources With Different Reference Distances For the Distance Attenuation Function

The MPEG-I Audio standard currently being developed allows setting a so-called “reference distance” attribute (“refDistance”) for an audio source, which specifies the distance from the source where the distance attenuation of the source should be 1. It can be seen as a normalization of the distance attenuation function of the source, which among other things allows some degree of level alignment between different renderers rendering the scene. The attribute has a default value of 1 m, but content creators are free to choose a different value for a source if that suits their needs.

Setting the reference distance attribute for a source to a different value than the default one results in the fact that the distance attenuation function of the source will be 1 at a different distance from the source than when the default value is used. This also results in the fact that, in general, the rendered direct sound level of the source will be different compared to if the default value is used (which may actually be the intention of the content creator when setting the different value for the source).

In general, setting the reference distance attribute for a source to a value RD instead of the default RD_def results in a change to the rendered level of the direct sound for the source compared to the corresponding level for the default value by a factor that is a function of RD and RD_def. As mentioned, this may actually be the intention of the content creator.

Specifically, setting the reference distance attribute for a point source to a value RD instead of the default RD_def results in a change to the rendered level of the direct sound for the source by a factor of RD/RD_def compared to the corresponding level for the default value.

For example, if a point-source audio source has a reference distance value of 2 m instead of the default 1 m, the rendered direct sound level of the source will effectively be raised by a factor of 2 (2 m/1 m) (i.e. 6 dB) everywhere compared to an identical audio source having the same source signal level but with the default reference distance value. Similarly, if the reference distance for the source has a value of 0.5, its rendered direct sound level will be 6 dB lower everywhere than when the default value of 1 m was used.

However, as the RDR measure and calibration of the renderer are likely determined for an omnidirectional point source having the default value for the reference distance, rendering a source with a value for the reference distance that is different from the default value may result in an incorrect balance between direct and reverberant sound components for the source. Because, while the rendered level of the direct sound is changed for the source due to the non-default reference distance, the source's signal level (i.e. the level of the signal provided for the source) is unchanged, and it is this signal that is provided to the reverberation unit to generate the reverberant component for the source.

So, in the example where the reference distance for the point source is 2 m instead of the default 1 m, the rendered level of the direct sound component for the source is raised by a factor of 2 (6 dB), while the rendered level of the reverberant component is the same as when the source would have the default value for the reference distance. So, the level of the reverberation will be too low, i.e. it will not have the correct balance to the level of the direct sound as specified by the RDR parameter.

Thus, in some embodiments, based on a function of the non-default reference distance and the default reference distance (e.g., a ratio between the non-default reference distance and the default reference distance), a relative gain for generating an adjusted audio signal 260 (shown in FIG. 2) may be generated. There may be various ways for generating the adjusted audio signal 260 using the relative gain. In one embodiment, the relative gain may be used to adjust the level of an input audio signal 256 corresponding to a source with a value for the reference distance that is different from the default value that is provided to the late reflected sound component unit 206, thereby generating the adjusted audio signal 260. In another embodiment, the relative gain may be used to adjust the level of the signal outputted from the late reflected sound component unit 206, thereby generating the adjusted audio signal 260. In a different embodiment, the relative gain may be used to adjust the configuration of the late reflected sound component unit 206 such that the unit generates the adjusted audio signal 260.

Specifically, the input signal level for the audio source going into the reverberation unit may be adjusted, such that the reverberant sound component produced by the reverberation unit for the source has the correct energy balance to the direct sound component again. For example, for a point source the input signal level for the source going into the reverberation unit may be adjusted by a factor of RD/RD_def (on a linear scale) or 20log₁₀(RD/RD_def) on a dB scale.

More generally, the relative gain compensates for the change to the level of the direct sound component for the source due to using the specific value of the reference distance instead of the default value. This change of the level of the direct sound component may be determined by evaluating the distance attenuation function associated with the source at the default and the specific reference distance and calculating the difference (if the gains are expressed on a logarithmic (dB) scale) or ratio (when the gains are expressed on a linear scale).

For example, in the case of a point source, which has a distance attenuation function that is proportional to 1/r (where r is the distance), the value of the distance attenuation function is 1/RD_def when using the default reference distance value, and 1/RD when using the specific reference distance value. Hence, the ratio of these two values results in the relative gain factor RD/RD_def to be applied to the input signal level for the point source going into the reverberation unit, as mentioned above.

For a non-point source, i.e., a source that is not a point source and/or has an associated distance attenuation function different from the 1/r function of a point source, the same approach for determining the relative gain factor may be used, using the specific distance attenuation function associated with the non-point source.

For example, if the source is an infinitely long line source with an associated distance attenuation function that is proportional to 1/sqrt(r), the relative gain factor may be determined as sqrt(RD/RD_def). In another example, if the source is an infinitely large planar source which has a constant distance attenuation function (i.e., the level of the direct sound component does not change with distance), the relative gain factor will be 1, regardless of the values of RD and RD_def.

In the most general case, the relative gain factor may be determined as DAF(RD_def)/DAF(RD), where DAF is the distance attenuation function of the source. U.S. patent application Ser. No. 17/344,632 disclose models for deriving the distance attenuation function for a source as a function of the size of the source in different dimensions. These documents are hereby incorporated by reference.

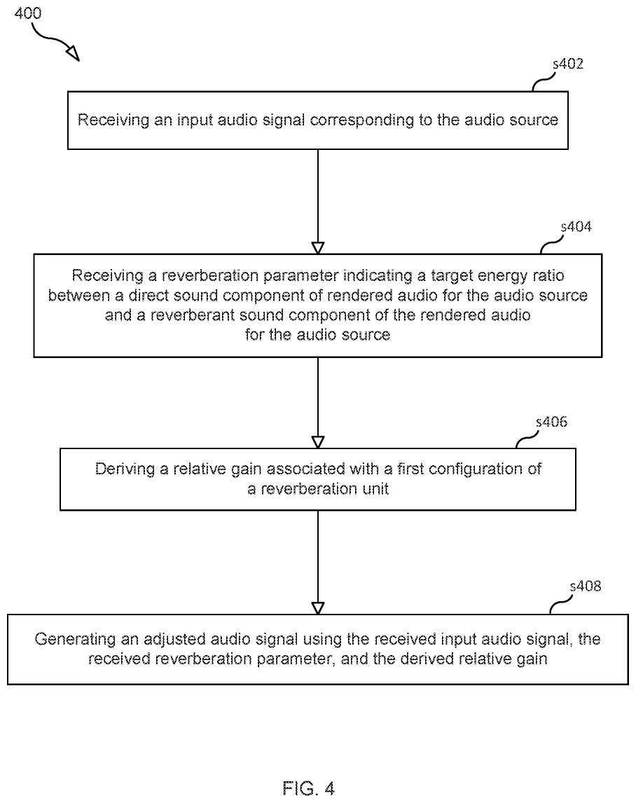

FIG. 4 shows a process 400 for rendering an audio source according to some embodiments of this disclosure. The process 400 may begin with step s402.

Step s402 comprises receiving an input audio signal corresponding to the audio source.

Step s404 comprises receiving a reverberation parameter indicating a target energy ratio between a direct sound component of rendered audio for the audio source and a reverberant sound component of the rendered audio for the audio source.

Step s406 comprises deriving a relative gain associated with a first configuration of a reverberation unit. The relative gain is with respect to a reference configuration of the reverberation unit.

Step s408 comprises generating an adjusted audio signal using the received input audio signal, the received reverberation parameter, and the derived relative gain.

In some embodiments, the relative gain corresponds to a difference between (i) a reference output of the reverberation unit associated with the reference configuration and (ii) a first output of the reverberation unit associated with the first configuration.

In some embodiments, deriving the relative gain comprises determining a reference output level of the reverberation unit for a reference input audio signal when the reverberation unit is configured with the reference configuration and determining a first output level of the reverberation unit for the reference input audio signal when the reverberation unit is configured with the first configuration. Deriving the relative gain further comprises calculating a difference between the reference output level and the first output level, and deriving the relative gain based on the calculated difference between the reference output level and the first output level. In some embodiments, the difference may be expressed using a logarithmic (dB) scale. However, in other embodiments, the difference may be expressed using a linear scale. In such embodiments, the difference may be equal to a ratio between the reference output level and the first output level.

In some embodiments, the reverberation parameter indicates the target energy ratio at a specific distance from the audio source.

In some embodiments, the reverberation parameter indicates the target energy ratio for a particular type of an audio source, and the particular type of the audio source is an omnidirectional audio source that is a point source.

In some embodiments, the reference configuration is a configuration used for calibrating an output level of the reverberation unit such that the target energy ratio is obtained at a specific distance from the audio source.

In some embodiments, the reference configuration is any one or a combination of: a reference room impulse response, a reference reverberation time setting, reference frequency response data, and reference absorption data.

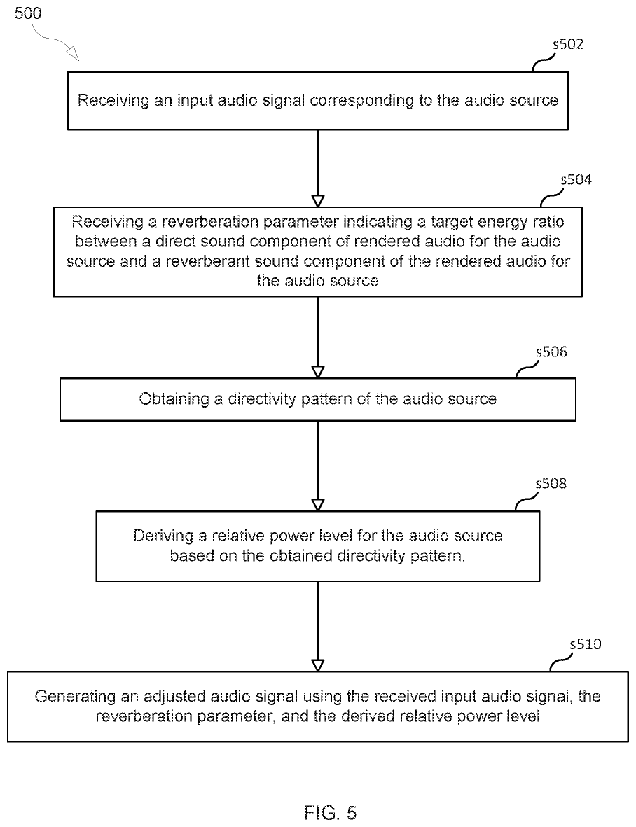

FIG. 5 shows a process 500 for rendering an audio source according to some embodiments of this disclosure. The process 500 may begin with step s502.

Step s502 comprises receiving an input audio signal corresponding to the audio source.

Step s504 comprises receiving a reverberation parameter indicating a target energy ratio between a direct sound component of rendered audio for the audio source and a reverberant sound component of the rendered audio for the audio source.

Step s506 comprises obtaining a directivity pattern of the audio source.

Step s508 comprises deriving a relative power level for the audio source based on the obtained directivity pattern. The relative power level is relative to a power level of an omnidirectional audio source.

Step s510 comprises generating an adjusted audio signal using the received input audio signal, the reverberation parameter, and the derived relative power level.

In some embodiments, the audio source is a non-omni directional audio source and/or a non-point source.

In some embodiments, the directivity pattern indicates an amplitude or a power of sound radiated by the audio source in each of a plurality of directions around the audio source.

In some embodiments, the relative power level is calculated based on Σᵢ₌₁^{m}Pᵢ where Pᵢ indicates a power of sound radiated by the audio source toward a particular direction, and m is the number of the plurality of directions around the audio source.

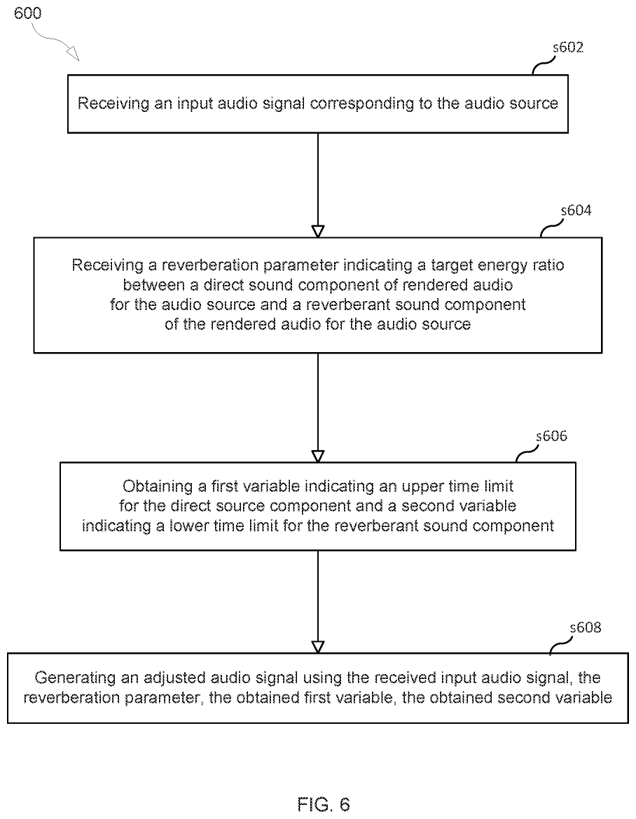

FIG. 6 shows a process 600 for rendering an audio source according to some embodiments of this disclosure. The process 600 may begin with step s602.

Step s602 comprises receiving an input audio signal corresponding to the audio source.

Step s604 comprises receiving a reverberation parameter indicating a target energy ratio between a direct sound component of rendered audio for the audio source and a reverberant sound component of the rendered audio for the audio source.

Step s606 comprises obtaining a first variable indicating an upper time limit for the direct source component and/or a second variable indicating a lower time limit for the reverberant sound component.

Step s608 comprises generating an adjusted audio signal using the received input audio signal, the reverberation parameter, the obtained first variable, and/or the obtained second variable.

In some embodiments, the reverberation parameter is calculated based on

$$10 {log}_{10} ( \frac{{\int }_{{t}_{2}}^{∞} {p}^{2} ( t ) dt}{{\int }_{0}^{{t}_{1}} {p}^{2} ( t ) dt} ) ,$$

where t₁ is the first variable, t₂ is the second variable, p(t) is the amplitude of a room impulse response of an acoustical environment at a time instant t.

In some embodiments, the method further comprises calculating a revised reverberation parameter using the received reverberation parameter and the obtained first and/or second variables. The adjusted audio signal is generated using the received input audio signal and the revised reverberation parameter.

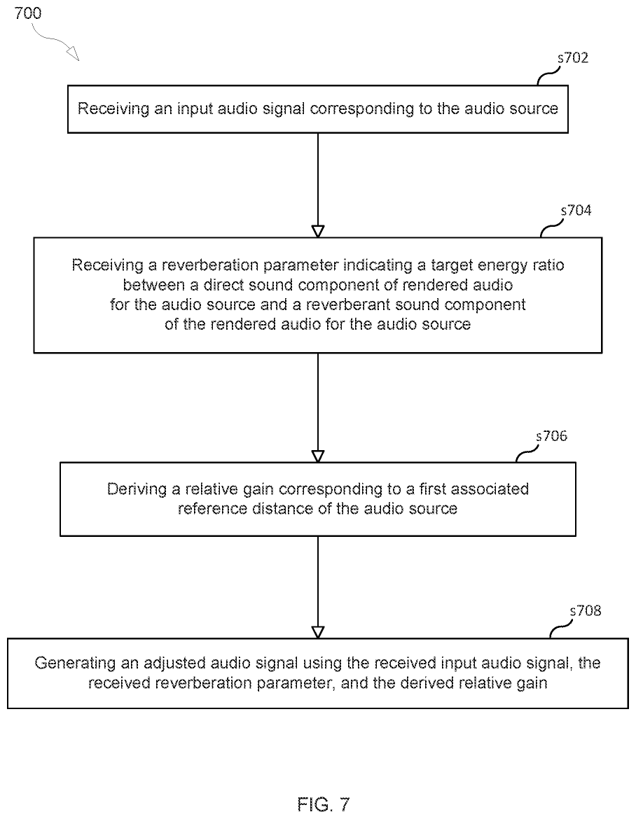

FIG. 7 shows a process 700 for rendering an audio source according to some embodiments of this disclosure. The process 700 may begin with step s702.

Step s702 comprises receiving an input audio signal corresponding to the audio source.

Step s704 comprises receiving a reverberation parameter indicating a target energy ratio between a direct sound component of rendered audio for the audio source and a reverberant sound component of the rendered audio for the audio source.

Step s706 comprises deriving a relative gain corresponding to a first associated reference distance of the audio source, wherein the relative gain is with respect to a default reference distance.

Step s708 comprises generating an adjusted audio signal using the received input audio signal, the received reverberation parameter, and the derived relative gain.

In some embodiments, the method further comprises obtaining the first associated reference distance of the audio source. The first associated reference distance indicates a distance from the audio source where a distance attenuation function associated with the audio source has a value of 1. The relative gain is derived based on a function of the first associated reference distance and the default reference distance.

In some embodiments, the relative gain is derived based on a ratio of the first associated reference distance and the default reference distance.

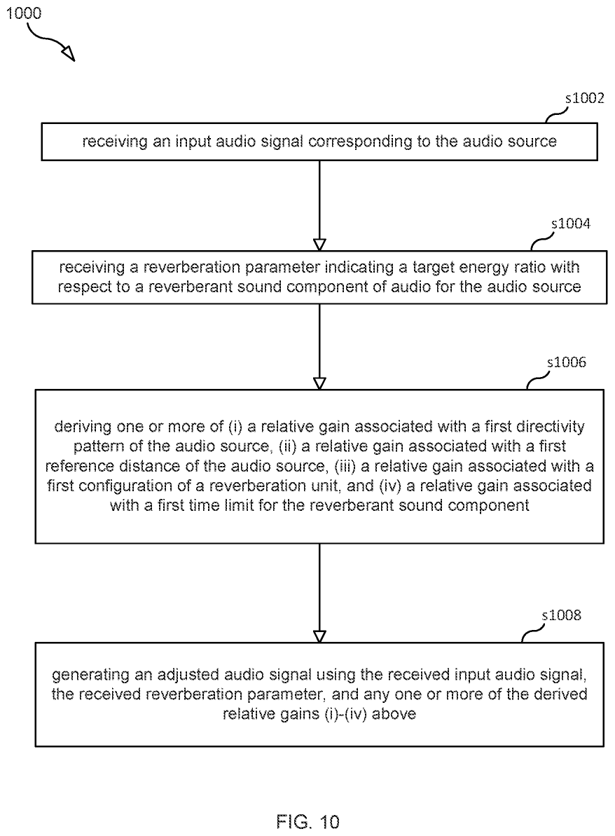

FIG. 10 shows a process 1000 of rendering an audio source. Process 1000 may begin with step s1002. Step s1002 comprises receiving an input audio signal corresponding to the audio source. Step s1004 comprises receiving a reverberation parameter indicating a target energy ratio with respect to a reverberant sound component of audio for the audio source. Step s1006 comprises deriving one or more of (i) a relative gain associated with a first directivity pattern of the audio source, (ii) a relative gain associated with a first reference distance of the audio source, (iii) a relative gain associated with a first configuration of a reverberation unit, and (iv) a relative gain associated with a first time limit for the reverberant sound component. Step s1008 comprises generating an adjusted audio signal using the received input audio signal, the received reverberation parameter, and any one or more of the derived relative gains (i)-(iv) above. The relative gain associated with the first directivity pattern is with respect to a reference directivity pattern, the relative gain associated with the first reference distance is with respect to a default reference distance, the relative gain associated with the first configuration is with respect to a reference configuration of the reverberation unit, and the relative gain associated with the first time limit is with respect to a second time limit for the reverberant sound component.

In some embodiments, the target energy ratio is a target energy ratio between a direct sound component of the audio for the audio source and the reverberant sound component of the audio for the audio source.

In some embodiments, the target energy ratio is a target energy ratio between a total energy emitted by the audio source and an energy corresponding to the reverberant sound component of the audio for the audio source.

In some embodiments, generating the adjusted audio signal comprises any one or a combination of: modifying the input audio signal based on one or more of the derived relative gains (i)-(iv); modifying one or more configurations of the reverberation unit such that the reverberation unit generates the adjusted audio signal based on one or more of the derived relative gains (i)-(iv); or modifying an output signal from the reverberation unit based on one or more of the derived relative gains (i)-(iv).

In some embodiments, the first directivity pattern is a directivity pattern of a non-omni directional audio source and/or a directivity pattern of a non-point audio source, and the reference directivity pattern is a directivity pattern of an omni directional audio source and/or a directivity pattern of a point audio source.

In some embodiments, the first directivity pattern indicates an amplitude or a power of sound radiated by the audio source in each of a plurality of directions around the audio source.

In some embodiments, the relative gain associated with the first directivity pattern of the audio source is calculated based on Σᵢ₌₁^{m}Pᵢ, Pᵢ indicates a power of sound radiated by the audio source toward a particular direction included in the plurality of directions, and m is the number of the plurality of directions.

In some embodiments, the first reference distance indicates a distance from the audio source where a distance attenuation function of the audio source has a value of 1, and the relative gain associated with the first reference distance of the audio source is derived based on a function of the first reference distance and the default reference distance.

In some embodiments, the relative gain associated with the first reference distance of the audio source is derived based on a ratio of the first reference distance and the default reference distance.

In some embodiments, the audio source is a non-omni directional audio source and/or a non-point audio source.

In some embodiments, the first time limit is associated with the received reverberation parameter.

In some embodiments, the relative gain associated with the first time limit is determined based on (i) a reverberation time associated with the reverberant sound component, and/or (ii) a difference or a ratio between the first time limit and the second time limit.

In some embodiments, the method further comprises calculating an updated reverberation parameter based on the received reverberation parameter and the relative gain associated with the first time limit, wherein the adjusted audio signal is generated based on the updated reverberation parameter.

In some embodiments, the relative gain associated with the first configuration corresponds to a difference or a ratio between a first output of the reverberation unit associated with the first configuration and a reference output of the reverberation unit associated with the reference configuration.

In some embodiments, the reverberation parameter indicates the target energy ratio at a specific distance from the audio source.

In some embodiments, the reverberation parameter indicates the target energy ratio for a particular type of an audio source, and the particular type of the audio source is an omnidirectional audio source that is a point source.

In some embodiments, the reference configuration is a configuration used for calibrating an output level of the reverberation unit such that the target energy ratio is obtained at a specific distance from the audio source.

In some embodiments, the reference configuration is a configuration associated with any one or a combination of: a reference room impulse response, a reference reverberation time setting, reference frequency response data, or reference absorption data.

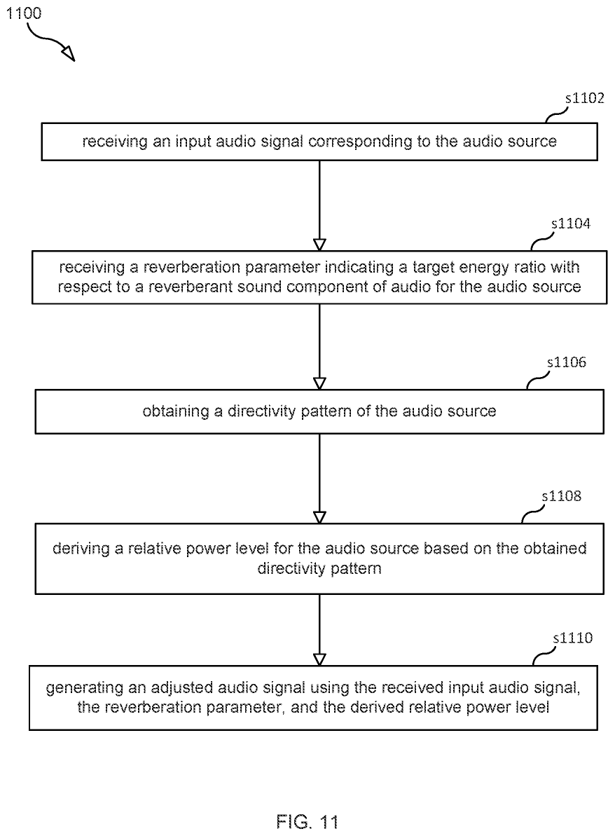

FIG. 11 shows a process 1100 of rendering an audio source. Process 1100 may begin with step s1102. Step s1102 comprises receiving an input audio signal corresponding to the audio source. Step s1104 comprises receiving a reverberation parameter indicating a target energy ratio with respect to a reverberant sound component of audio for the audio source. Step s1106 comprises obtaining a directivity pattern of the audio source. Step s1108 comprises deriving a relative power level for the audio source based on the obtained directivity pattern, wherein the relative power level is relative to a power level of an omnidirectional audio source. Step s1110 comprises generating an adjusted audio signal using the received input audio signal, the reverberation parameter, and the derived relative power level.

In some embodiments, the target energy ratio is between a direct sound component of the audio for the audio source and the reverberant sound component of the audio for the audio source.

In some embodiments, the audio source is a non-omni directional audio source and/or a non-point source.

In some embodiments, the directivity pattern indicates an amplitude or a magnitude of sound radiated by the audio source in each of a plurality of directions around the audio source.

In some embodiments, the relative power level is calculated based on Σᵢ₌₁^{m}Pᵢ, Pᵢ indicates a magnitude of sound radiated by the audio source toward a particular direction, and m is the number of the plurality of directions.

In some embodiments, Pᵢ=Aᵢ², where Aᵢ is the magnitude of sound radiated by the audio source toward the particular direction.

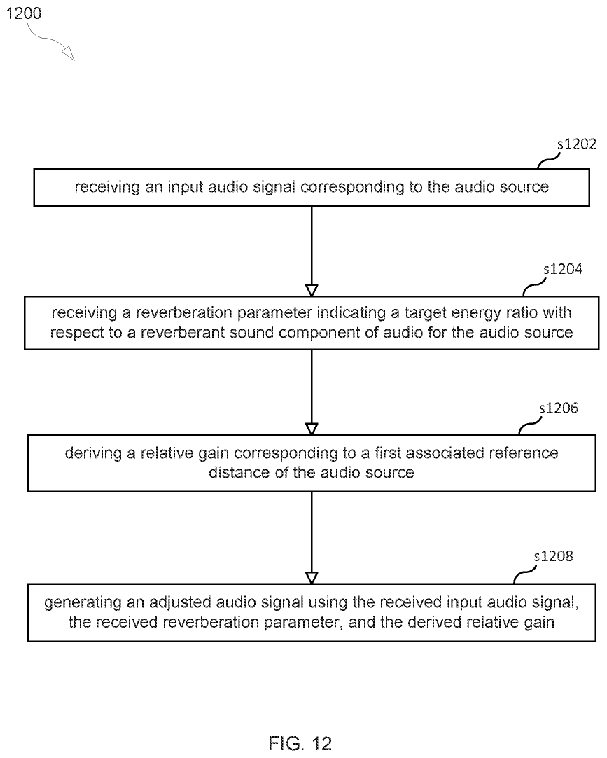

FIG. 12 shows a process 1200 of rendering an audio source. Process 1200 may begin with step s1202. Step s1202 comprises receiving an input audio signal corresponding to the audio source. Step s1204 comprises receiving a reverberation parameter indicating a target energy ratio with respect to a reverberant sound component of audio for the audio source. Step s1206 comprises deriving a relative gain corresponding to a first associated reference distance of the audio source. Step s1208 comprises generating an adjusted audio signal using the received input audio signal, the received reverberation parameter, and the derived relative gain.

In some embodiments, the relative gain is with respect to a default reference distance.

In some embodiments, the method further comprises obtaining the first associated reference distance of the audio source, wherein the first associated reference distance indicates a distance from the audio source where a distance attenuation function associated with the audio source has a value of 1, wherein the relative gain is derived based on a function of the first associated reference distance and the default reference distance.

In some embodiments, the relative gain is derived based on a ratio of the first associated reference distance and the default reference distance.

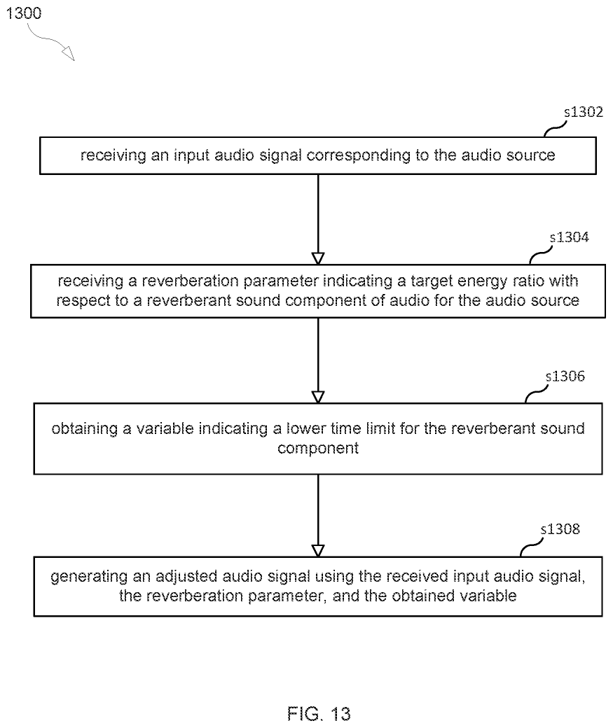

FIG. 13 shows a process 1300 of rendering an audio source. Process 1300 may begin with step s1302. Step s1302 comprises receiving an input audio signal corresponding to the audio source. Step s1304 comprises receiving a reverberation parameter indicating a target energy ratio with respect to a reverberant sound component of the rendered audio for the audio source. Step s1306 comprises obtaining a variable indicating a lower time limit for the reverberant sound component. Step s1308 comprises generating an adjusted audio signal using the received input audio signal, the reverberation parameter, and the obtained variable.

In some embodiments, the method further comprises calculating a revised reverberation parameter using the received reverberation parameter and the obtained variable, wherein the adjusted audio signal is generated using the received input audio signal and the revised reverberation parameter.

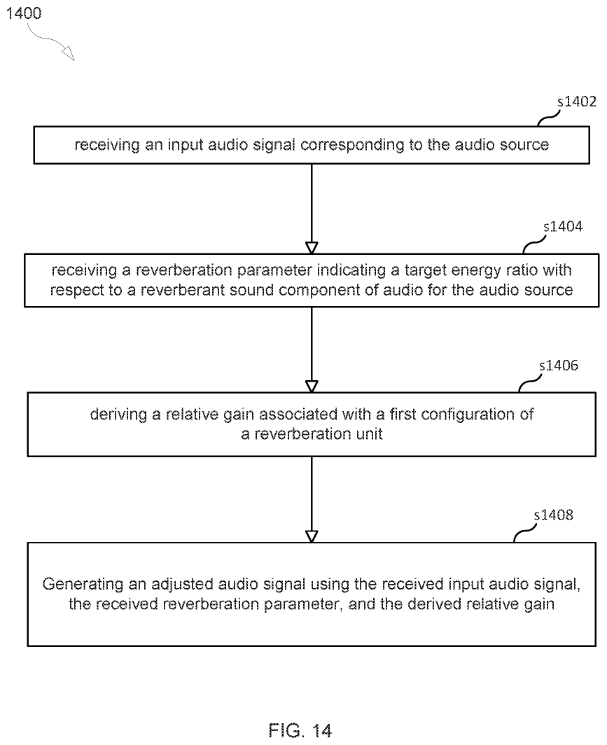

FIG. 14 shows a process 1400 of rendering an audio source. Process 1400 may begin with step s1402. Step s1402 comprises receiving an input audio signal corresponding to the audio source. Step s1404 comprises receiving a reverberation parameter indicating a target energy ratio with respect to a reverberant sound component of the rendered audio for the audio source. Step s1406 comprises deriving a relative gain associated with a first configuration of a reverberation unit, wherein the relative gain is with respect to a reference configuration of the reverberation unit. Step s1408 comprises generating an adjusted audio signal using the received input audio signal, the received reverberation parameter, and the derived relative gain.

In some embodiments, the relative gain corresponds to a difference between (i) a reference output of the reverberation unit associated with the reference configuration and (ii) a first output of the reverberation unit associated with the first configuration.

In some embodiments, deriving the relative gain comprises: determining a reference output level of the reverberation unit for a reference input audio signal when the reverberation unit is configured with the reference configuration, determining a first output level of the reverberation unit for the reference input audio signal when the reverberation unit is configured with the first configuration, calculating a difference between the reference output level and the first output level, and deriving the relative gain based on the calculated difference between the reference output level and the first output level.

In some embodiments, the reverberation parameter indicates the target energy ratio at a specific distance from the audio source.

In some embodiments, the reverberation parameter indicates the target energy ratio for a particular type of an audio source, and the particular type of the audio source is an omnidirectional audio source that is a point source.

In some embodiments, the reference configuration is a configuration used for calibrating an output level of the reverberation unit such that the target energy ratio is obtained at a specific distance from the audio source.

In some embodiments, the reference configuration is a configuration associated with any one or a combination of: a reference room impulse response, a reference reverberation time setting, reference frequency response data, and reference absorption data.

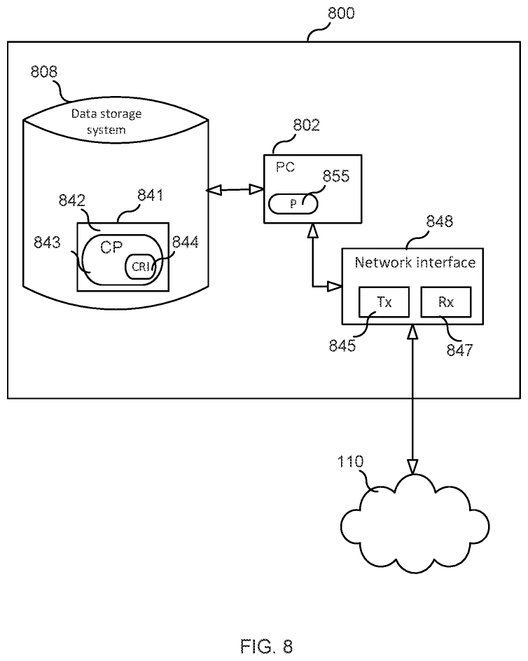

FIG. 8 is a block diagram of an apparatus 800, according to some embodiments, for implementing the audio renderer 200 shown in FIG. 2. As shown in FIG. 8, apparatus 800 may comprise: processing circuitry (PC) 802, which may include one or more processors (P) 855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 800 may be a distributed computing apparatus); at least one network interface 848, each network interface 848 comprises a transmitter (Tx) 845 and a receiver (Rx) 847 for enabling apparatus 800 to transmit data to and receive data from other nodes connected to a network 110 (e.g., an Internet Protocol (IP) network) to which network interface 848 is connected (directly or indirectly) (e.g., network interface 848 may be wirelessly connected to the network 110, in which case network interface 848 is connected to an antenna arrangement); and one or more storage units (a.k.a., “data storage system”) 808, which may include one or more non-volatile storage devices and/or one or more volatile storage devices. In embodiments where PC 802 includes a programmable processor, a computer program product (CPP) 841 may be provided. CPP 841 includes a computer readable medium (CRM) 842 storing a computer program (CP) 843 comprising computer readable instructions (CRI) 844. CRM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes apparatus 800 to perform steps described herein (e.g., steps described herein with reference to the flow charts). In other embodiments, apparatus 800 may be configured to perform steps described herein without the need for code. That is, for example, PC 802 may consist merely of one or more ASICs. Hence, the features of the embodiments described herein may be implemented in hardware and/or software.

### Additional Information Section

### 1. Purpose and Desirable Properties For the Measure Under Discussion

The purpose of the measure under discussion (currently called DDR) is to enable setting the relative level of late reverberation in rendering a scene, such that it has the correct balance to the level of the direct sound at all positions in the room (“correct” in the sense of: as it was intended by the scene creator).

With this purpose in mind, a suitable measure preferably has the following properties:
The measure should be easy to interpret by scene creators and renderer implementers, i.e. it should be intuitively clear what it represents. Preferably, the value of the measure should also be easily interpretable in the context of related acoustical measures.
It should be possible to derive the measure in different scene authoring scenarios, and it should be clear to scene creators how this can be done.
As with RT60, the measure should preferably leave a lot of freedom to renderer implementers regarding how to make use of the measure to achieve a good rendering result, without requiring the use a specific algorithm for interpreting the measure. Also, the measure should support the use of different types of reverb generating techniques.
The measure should be a property of the acoustic environment only, meaning that e.g. properties of any specific source should not play any role in determining the measure.
Absolute levels are not relevant, it's all about the balance between two levels/energies.

The measure proposed in this document is believed to have all the properties listed above. It is simple to understand and use, and is applicable both in authoring scenarios where (measured or simulated) RIR' s are used as a basis for determining the acoustical parameters of a scene, as well as in authoring scenarios in which a more “sound designer” procedure is used where the balance of direct sound and late reverberation is tuned by the scene creator on an artistic basis. Similarly, the proposed measure supports a large variety of rendering scenarios.

### 2. Description of Proposed Measure

It is proposed to use the common direct-to-reverberant energy ratio (DRR) or its inverse (RDR) as indicator for the relative level of the late reverberation.

RDR is generally defined as the ratio of the energies of late reverberant sound and direct sound at a given location. This general definition has an intuitive and straightforward meaning both in the context of audio systems that separately generate the different components of the sound field, as well as those that use room impulse response (RIR) based methods. In the latter case RDR can be expressed as:

$$RDR = 10 {log}_{10} ( \frac{{\int }_{{t}_{2}}^{∞} {p}^{2} ( t ) dt}{{\int }_{0}^{{t}_{1}} {p}^{2} ( t ) dt} ) dB , \qquad ( Eq . 1 )$$

where t=0 is the onset of the direct sound, and the values of t₁ and t₂ should be suitably chosen for our purpose.

Since the general definition of RDR given above depends on the distance to and radiation properties of the source, we propose to more specifically define the measure to be used as: The ratio of the energies of late reverberation and direct sound (RDR) at 1 m distance from an omnidirectional point source.

By specifying the distance to the source and by specifying it to be an omnidirectional point source, the proposed measure as defined above is unambiguous and in addition enables inference of the ratio of direct sound and late reverberation at any position in the room. This is because the level of the late reverberation is the same throughout the room (by definition), and the direct sound level of the omnidirectional point source follows the known 1/r distance law.

It should be noted that for the omnidirectional point source that is specified in the proposed measure, the energy of the direct sound is directly proportional to the total emitted energy of the source, so the proposed measure is essentially consistent with the general definition of DDR that is currently in the EIF.

Note also that the additional pre-defined information about the source-receiver distance is what was missing in previous proposals to use the direct-to-reverberant ratio as measure in the EIF.

### 3. Conceptual Method for Determining the Proposed Measure

On the scene authoring side, the value of the proposed measure for an acoustic environment may be determined by means of a simple conceptual procedure that consists of:
Placing an omnidirectional point source (test source) at a sensible position inside the acoustic environment
Placing an omnidirectional receiver at a sensible position at the prescribed distance (1 m) from the source,
Rendering the source and measuring the energies of the direct sound and late reverberation at the receiver.

Above, “sensible” means e.g. not with any occluder between the source and receiver positions used to determine the measure, or directly next to a reflecting surface. Other than that, there are no specific requirements.

This conceptual method is believed to allow obtaining the value of the proposed measure in all relevant scene authoring scenarios. Specifically, it allows:
Determining the proposed measure from (measured or simulated) RIR' s of the acoustical environment (using Eq. 1) (Note that even if the RIR measurement was done with a different source-receiver distance, it is possible to correct for this as long as the distance is known or can be deduced (e.g. from TOA of the direct sound)), and
Determining the proposed measure from the rendered levels of separate direct sound and late reverb rendering modules, tuned to a suitable balance by ear (sound designer approach).

### 4. Conceptual Method for Using the Proposed Measure for Renderer Calibration

On the rendering side, essentially the same conceptual method as described above for deriving the proposed measure may be used to calibrate the renderer such that it produces the desired balance between direct sound and late reverberation everywhere in the acoustic environment, i.e.:
Placing and rendering an omnidirectional point source in the acoustic environment, and
Measuring the energy ratio of direct sound and late reverb with an omnidirectional receiver placed at the prescribed distance from the source.

The energy ratio thus obtained can be compared directly to the desired value (the value provided for the acoustic environment), and the output level of the late reverb rendering module can be adjusted accordingly.

On the rendering side also, this conceptual method is believed to be applicable to all relevant scenarios, in particular:
RIR-based rendering (e.g. by doing real-time calculation of RIR)
Separate rendering modules for direct sound and late reverberation, the outputs of which are mixed together.

It is important to note that the conceptual renderer calibration procedure described above in principle only needs to be carried out once to correctly set the “master” level of the late reverb rendering stage of a renderer. Once this is done for an arbitrary acoustical test environment and value of the proposed measure, there is a straightforward relationship between the received value for any acoustic environment to be rendered and the adjustment that needs to be made to the level of the late reverb stage to realize the desired balance. In other words, there is no need for a per-scene calibration.

### 5. Alternative Formulation as Critical Distance

An alternative, equivalent way for conveying the same information as contained in the RDR-based measure described above, is to instead specify the Critical Distance (CD) for the acoustic environment.

CD is defined as the distance where the direct sound and late reverberation are equally strong. So, CD essentially conveys the same information as RDR in a different form, i.e. specifying the distance where RDR is 0 dB instead of specifying RDR at a given distance. Indeed, for the omnidirectional point source there is a very simple relationship between the two measures:

$$RDR = - 20 {log}_{10} ( \frac{CD}{{d}_{r s}} ) ,$$

where dᵣₛ is the distance between the source and the receiver. So, for our predetermined source-receiver distance of 1 m, the relationship simplifies further to:

RDR=−20 log₁₀(CD).

For determining CD on the authoring side, essentially the same conceptual method as described for RDR above may be used, with the difference that one now has to find the distance at which the direct sound and late reverb are equally strong. However, as described above there is a trivial relationship between CD and RDR for the monopole point source, so that CD can also be obtained using the method described for RDR (and vice versa).

Similarly, the conceptual method for renderer calibration described above for RDR can be used for CD as well, with a similar obvious modification (i.e. measuring the balance at the specified critical distance, and adjusting the level of the late reverb such that the energy of direct sound and late reverb are equal).

1. A method of rendering an audio source, the method comprising:
receiving an input audio signal corresponding to the audio source;
receiving a reverberation parameter indicating a target energy ratio with respect to a reverberant sound component of audio for the audio source;
obtaining a directivity pattern of the audio source;
deriving a relative gain for the audio source based on the obtained directivity pattern, wherein the relative gain is relative to an omnidirectional audio source; and
generating an adjusted audio signal using the received input audio signal, the reverberation parameter, and the derived relative gain.

2. The method of claim 1, wherein
the target energy ratio is between a direct sound component of the audio for the audio source and the reverberant sound component of the audio for the audio source or between a total energy emitted by the audio source and an energy corresponding to the reverberant sound component of the audio for the audio source.

3. The method of claim 1, wherein the audio source is a non-omni directional audio source and/or a non-point source.

4. The method of claim 1, wherein the directivity pattern indicates an amplitude or a magnitude of sound radiated by the audio source in each of a plurality of directions around the audio source.

5. The method of claim 4, wherein
the relative gain is calculated based on Σᵢ₌₁^{m}Pᵢ,
Pᵢ indicates a magnitude of sound radiated by the audio source toward a particular direction, and
m is the number of the plurality of directions.

6. The method of claim 5, wherein Pᵢ=Aᵢ², where Aᵢ is the magnitude of sound radiated by the audio source toward the particular direction

7. A method of rendering an audio source, the method comprising:
receiving an input audio signal corresponding to the audio source;
receiving a reverberation parameter indicating a target energy ratio with respect to a reverberant sound component of audio for the audio source;
deriving a relative gain corresponding to a first associated reference distance of the audio source; and
generating an adjusted audio signal using the received input audio signal, the received reverberation parameter, and the derived relative gain.

8. The method of claim 7, wherein the relative gain is with respect to a default reference distance.

9. The method of claim 8, the method further comprising:
obtaining the first associated reference distance of the audio source, wherein the first associated reference distance indicates a distance from the audio source where a distance attenuation function associated with the audio source has a value of 1, wherein
the relative gain is derived based on a function of the first associated reference distance and the default reference distance.

10. The method of claim 9, wherein the relative gain is derived based on a ratio of the first associated reference distance and the default reference distance.

11. A method of rendering an audio source, the method comprising:
receiving an input audio signal corresponding to the audio source;
receiving a reverberation parameter indicating a target energy ratio with respect to a reverberant sound component of the rendered audio for the audio source;
obtaining a variable indicating a first time limit for the reverberant sound component; and
generating an adjusted audio signal using the received input audio signal, the reverberation parameter, and the obtained variable.

12. The method of claim 11, the method further comprising:
calculating a revised reverberation parameter using the received reverberation parameter and the obtained variable, wherein
the adjusted audio signal is generated using the received input audio signal and the revised reverberation parameter.

13. A method of rendering an audio source, the method comprising:
receiving an input audio signal corresponding to the audio source;
receiving a reverberation parameter indicating a target energy ratio with respect to a reverberant sound component of the rendered audio for the audio source;
deriving a relative gain associated with a first configuration of a reverberation unit, wherein the relative gain is with respect to a reference configuration of the reverberation unit; and
generating an adjusted audio signal using the received input audio signal, the received reverberation parameter, and the derived relative gain.

14. The method of claim 13, wherein the relative gain corresponds to a difference between (i) a reference output of the reverberation unit associated with the reference configuration and (ii) a first output of the reverberation unit associated with the first configuration.

15. The method of claim 13, wherein deriving the relative gain comprises:
determining a reference output level of the reverberation unit for a reference input audio signal when the reverberation unit is configured with the reference configuration,
determining a first output level of the reverberation unit for the reference input audio signal when the reverberation unit is configured with the first configuration,
calculating a difference between the reference output level and the first output level, and
deriving the relative gain based on the calculated difference between the reference output level and the first output level.

16. The method of claim 13, wherein the reverberation parameter indicates the target energy ratio at a specific distance from the audio source.

17. The method of claim 13, wherein
the reverberation parameter indicates the target energy ratio for a particular type of an audio source, and
the particular type of the audio source is an omnidirectional audio source that is a point source.

18. The method of claim 13, wherein the reference configuration is a configuration used for calibrating an output level of the reverberation unit such that the target energy ratio is obtained at a specific distance from the audio source.

19. The method of claim 13, wherein the reference configuration is a configuration associated with any one or a combination of:
a reference room impulse response,
a reference reverberation time setting,
reference frequency response data, and
reference absorption data.
